(19) United States
(12) Patent Application Publication
(10) Pub. No.: US 2021/0022576 A1
(43) Pub. Date: Jan. 28, 2021

(54) VACUUM CLEANER HOSE ADAPTER

(71) Applicant: Hilti Aktiengesellschaft, Schaan (LI)

(72) Inventors: Xaver HANSLMEIER, Mauerstetten (DE); Oliver OHLENDORF, Landsberg (DE)

(21) Appl. No.: 16/977,853

(22) PCT Filed: Mar. 14, 2019
(86) PCT No.: PCT/EP2019/056426

§ 371 Date: Sep. 3, 2020

(30) Foreign Application Priority Data
Mar. 22, 2018 (EP) 18163242.3

(51) Int. Cl. A47L 9/24

(52) U.S. Cl. CPC A47L 9/242; A47L 7/0004; A47L 9/248

(57) ABSTRACT

Vacuum cleaner hose adapter for connecting to a vacuum cleaner hose of a wet and dry vacuum cleaner, wherein the vacuum cleaner hose has an inner lumen extending in the longitudinal direction, wherein a flow guiding geometry is formed within the vacuum cleaner hose adapter, by which a suction flow occurring during the operation of the wet and dry vacuum cleaner can be influenced.

The present invention relates to a vacuum cleaner hose adapter for connecting to a vacuum cleaner hose of a wet and dry vacuum cleaner, wherein the vacuum cleaner hose has an inner lumen extending in the longitudinal direction.

### BACKGROUND

Vacuum cleaner hose adapters of the type stated at the outset are known in principle from the prior art, e.g. in the form of connection adapters, by means of which a vacuum cleaner hose can be connected to a wet and dry vacuum cleaner. However, the present invention provides a new type of vacuum cleaner hose adapter.

### SUMMARY OF THE INVENTION

It is an object of the present invention to provide a vacuum cleaner hose adapter which at least promotes an increase in an overall efficiency of a wet and dry vacuum cleaner.

The present invention provides a flow guiding geometry formed within the vacuum cleaner hose adapter, by means of which a suction flow occurring during the operation of the wet and dry vacuum cleaner can be influenced.

The invention incorporates the insight a vacuum cleaner hose, particularly in the form of a spiral hose, causes relatively high pressure and flow losses owing to its geometry. These losses are primarily caused by high wall friction and edge swirling transversely to the hose axis. These losses impair the overall efficiency of a wet and dry vacuum cleaner considerably.

By means of the invention, a vacuum cleaner hose adapter is now created which can preferably be inserted between two vacuum cleaner hose sections, which, by virtue of its flow guiding geometry, promotes a longitudinal vortex form and centering of the suction flow and thus allows relatively low-loss media transfer. It is advantageously possible to incorporate a plurality of vacuum cleaner hose adapters into a vacuum cleaner hose in order to locally refresh any attenuated longitudinal swirling.

It has proven advantageous if the flow guiding geometry has a central guiding body. The central guiding body can be arranged coaxially with the longitudinal direction of the vacuum cleaner hose adapter.

It has proven advantageous if the central guiding body is designed as a solid body. As an alternative, the central guiding body, for its part, can have a flow channel. A flow channel of this kind is preferably arranged coaxially with the central guiding body and thus coaxially with the longitudinal direction of the vacuum cleaner hose adapter.

In a particularly preferred embodiment, the flow guiding geometry has a plurality of spokes, which preferably extend inward in the radial direction.

It has proven advantageous if the flow guiding geometry extends over the total length of the vacuum cleaner hose adapter.

The flow guiding geometry can have a cross section in the form of a sun wheel or a four-way lug wrench.

In one particularly preferred embodiment, the vacuum cleaner hose adapter is designed as an intermediate adapter. In other words, a respective vacuum cleaner hose section can be connected on each of the two sides of the vacuum cleaner hose adapter. A cascade of a plurality of vacuum cleaner hose adapters, preferably spaced apart from one another, is thus also possible within one and the same vacuum cleaner hose.

As an alternative to the embodiment as an intermediate adapter, the vacuum cleaner hose adapter can be designed as an end-located adapter. In this case, an embodiment as a nozzle is possible, for example.

In another preferred embodiment, the vacuum cleaner hose adapter has a retention element. The retention element is preferably in the form of a flexible retention ring. A vacuum cleaner hose adapter designed as an intermediate adapter can have two opposite retention elements. If the vacuum cleaner hose adapter is designed as an end-located adapter, just one retention element in the form of a flexible retention ring is preferably provided.

In one particularly preferred embodiment, the vacuum cleaner hose adapter is of double-shell design. This allows particularly easy cleaning of a hose system with a vacuum cleaner hose and a vacuum cleaner hose adapter.

The vacuum cleaner hose adapter is preferably manufactured from plastic.

The present invention also provides a vacuum cleaner hose for connection to a wet and dry vacuum cleaner, wherein at least one vacuum cleaner hose adapter as described above is arranged or can be arranged on the vacuum cleaner hose.

The vacuum cleaner hose adapter or adapters can be secured permanently on the vacuum cleaner hose.

The vacuum cleaner hose is preferably designed as a spiral hose.

The present invention also provides a vacuum cleaner hose having one or more vacuum cleaner hose adapters of the type described above.

### BRIEF DESCRIPTION OF THE DRAWINGS

Further advantages will become apparent from the following description of the figures. Various exemplary embodiments of the present invention are illustrated in the figures. The figures, the description and the claims contain numerous features in combination. A person skilled in the art will expediently also consider the features individually and combine them to form expedient further combinations.

In the figures, identical components and components of identical type are designated by the same reference signs. In the figures:

FIG. 1 shows a first preferred exemplary embodiment of a vacuum cleaner hose adapter according to the invention attached to a vacuum cleaner hose;

FIG. 2 shows the vacuum cleaner hose adapter of FIG. 1 in the attached and the detached state;

FIG. 3 shows the vacuum cleaner hose adapter of FIGS. 1 and 2 in cross section;

FIG. 4 shows the vacuum cleaner hose adapter of FIG. 3 in a perspective illustration;

FIG. 5 shows a cross section through the vacuum cleaner hose adapter in the previous figures to illustrate the flow behavior;

FIG. 6 shows a cross section of a second exemplary embodiment of a vacuum cleaner hose adapter according to the invention; and

FIG. 7 shows a cross section through a third preferred exemplary embodiment of a vacuum cleaner hose adapter according to the invention.

### DETAILED DESCRIPTION

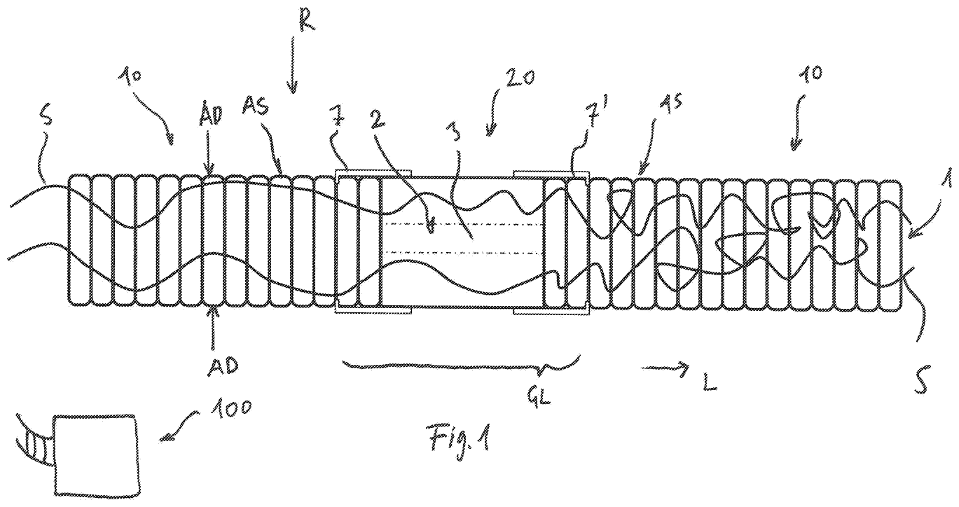

A preferred exemplary embodiment of a device 10 according to the invention is illustrated in FIG. 1.

A vacuum cleaner hose adapter 20 for connecting to a vacuum cleaner hose 10 of a wet and dry vacuum cleaner 100 is illustrated in FIG. 1. The vacuum cleaner hose 10 has an inner lumen 1 extending in the longitudinal direction L.

According to the invention, a flow guiding geometry 2 is formed within the vacuum cleaner hose adapter 20, by means of which a suction flow S occurring within the vacuum cleaner hose 10 during the operation of the wet and dry vacuum cleaner 100 can be influenced with flow proceeding from the right to the left in FIG. 1.

First of all, it should be mentioned that the vacuum cleaner hose adapter 20 is designed as an intermediate adapter, that is to say that a respective section of the vacuum cleaner hose 10 is connected on each side of the vacuum cleaner hose adapter 20 (on the left and right in FIG. 1).

A suction flow S prevailing on the right-hand side of the vacuum cleaner hose adapter 20 is subject to relatively strong turbulence, that is to say, in particular, there is intense edge swirling transversely to the longitudinal direction L of the vacuum cleaner hose 10. This leads to a negative influence on the overall efficiency of the wet and dry vacuum cleaner 100. By virtue of the vacuum cleaner hose adapter 20, which, in this case, is fitted with a central guiding body 3 for example, swirling transversely to the hose axis is significantly reduced and converted into a preferred longitudinal vortex form which allows a lower loss of media transfer.

This advantageous longitudinal vortex form continues on the left-hand side of the vacuum cleaner hose adapter 20. In order to avoid any reoccurrence of transverse swirling downstream, a further vacuum cleaner hose adapter can be incorporated into the vacuum cleaner hose 10.

The vacuum cleaner hose adapter 20 designed as an intermediate adapter has two retention elements in the form of flexible retention rings 7, 7′, which are fitted over a respective outside diameter AD of the vacuum cleaner hose 10.

In FIG. 1, the vacuum cleaner hose 10 is designed as a spiral hose. The vacuum cleaner hose 10 has a constant outside diameter AD over its length. This is not taking into account the surface ribbing of the vacuum cleaner hose 10, which is designed as a spiral hose.

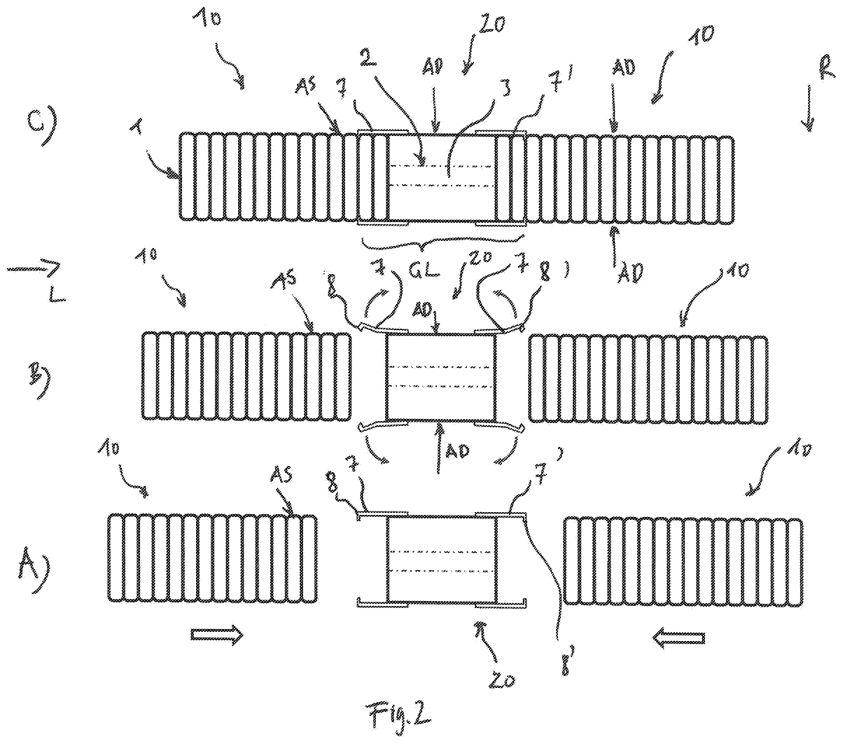

With reference to FIG. 2, the attachment of a vacuum cleaner hose adapter 20 to a vacuum cleaner hose 10 will now be illustrated.

FIG. 2A shows, centrally, the vacuum cleaner hose adapter 20 with two retention elements in the form of flexible retention rings 7, 7′. The retention rings 7, 7′ each have an encircling lip 8, 8′, which can engage in a ridged profile of the spiral hose, said profile being situated on the hose outside AS.

Insertion of the respective sections of the vacuum cleaner hose 10 into the vacuum cleaner hose adapter 20, this being illustrated in FIG. 2B, causes the respective retention rings 7, 7′ to expand and, if the respective hose ends are inserted fully into the vacuum cleaner hose adapter 20, said rings come to rest on the hose outside AS to form a latching joint. The retention rings 7, 7′ can be of such reversibly flexible design that they can be pushed onto the vacuum cleaner hose 10 only with the exertion of a high force.

As an alternative or in addition, an outer sleeve (not illustrated) can be provided for each of the retention rings 7, 7′ or, alternatively, for the vacuum cleaner hose adapter 20 as a whole, said sleeve being pushed over the vacuum cleaner hose adapter 20 after the attachment of the latter in order to prevent expansion of the retention rings 7, 7′.

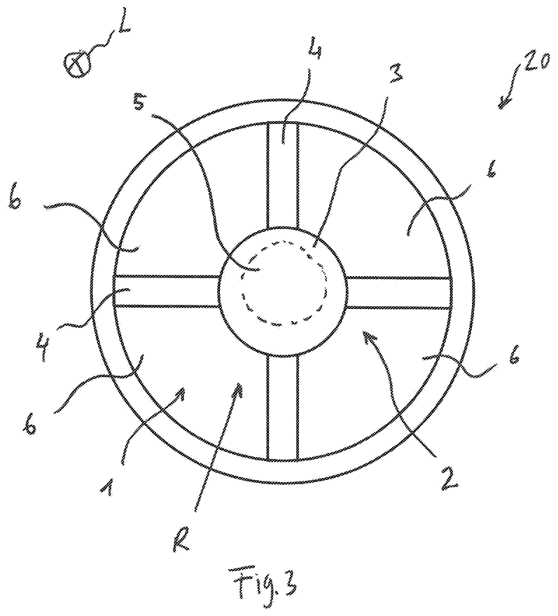

FIG. 3 now shows a cross section of a preferred exemplary embodiment of a vacuum cleaner hose adapter according to the invention. The vacuum cleaner hose adapter 20 has a flow guiding geometry 2 which, in the present case, has four spokes 4, which extend inward in the radial direction R. The flow guiding geometry 2 furthermore has a central guiding body 3, which is arranged coaxially with the longitudinal direction L of the vacuum cleaner hose adapter 20. The spokes 4 do not necessarily serve only for flow guidance but also hold the central guiding body 3 in its coaxial position.

In the case of the preferred exemplary embodiment in FIG. 3, the central guiding body 3 is designed as a solid body. As an alternative, which may be indicated by the dashed line, the central guiding body 3 may, for its part, have an inner flow channel.

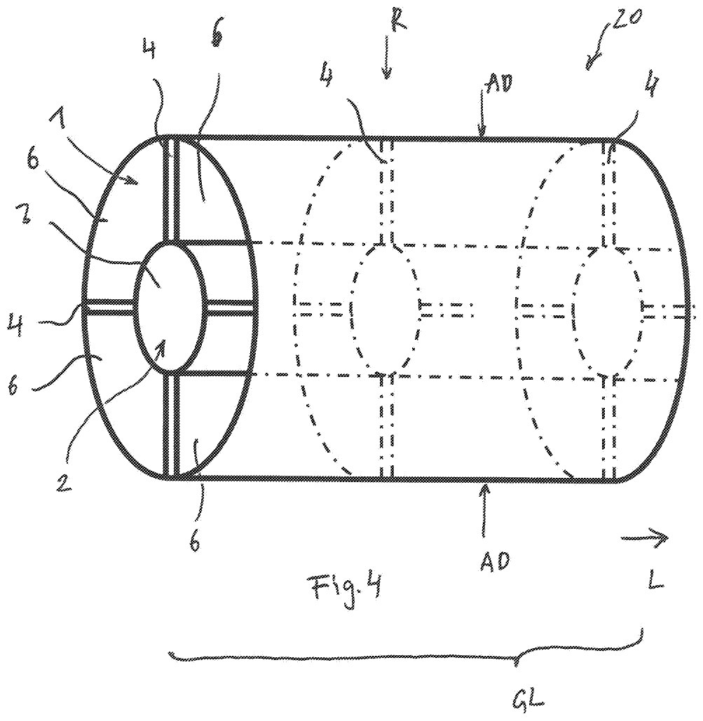

As can be seen from FIG. 3, the flow guiding geometry 2 has a cross section in the form of a four-way lug wrench. The inner lumen 1 is thereby divided into four bypass channels 6 with the same cross section. The bypass channels do not necessarily have to have a cross section of the same size. Through suitable positioning of the spokes 4, it is possible, for example, to structurally form two larger and two smaller bypass channels 6. The flows through the four bypass channels 6 are not separated from one another since the four spokes 4 do not extend over the total length GL of the vacuum cleaner hose adapter 20, cf. FIG. 4.

FIG. 4 now shows a perspective illustration of the vacuum cleaner hose adapter 20 in FIG. 3. As can be seen from FIG. 4, the central guiding body 3 of the flow guiding geometry 2 extends over the total length of the vacuum cleaner hose adapter 20.

It can clearly be seen that the spokes 4 are provided merely to support the guiding body 3 and do not extend over the total length GL of the vacuum cleaner hose adapter 20.

In a version that is not illustrated here, the spokes 4 can extend over the total length GL of the vacuum cleaner hose adapter 20. By means of the central guiding body 3 and the plurality of spokes 4, the inner lumen 1 is then divided into four discrete bypass channels 6, which each extend over the total length GL of the vacuum cleaner hose adapter 20.

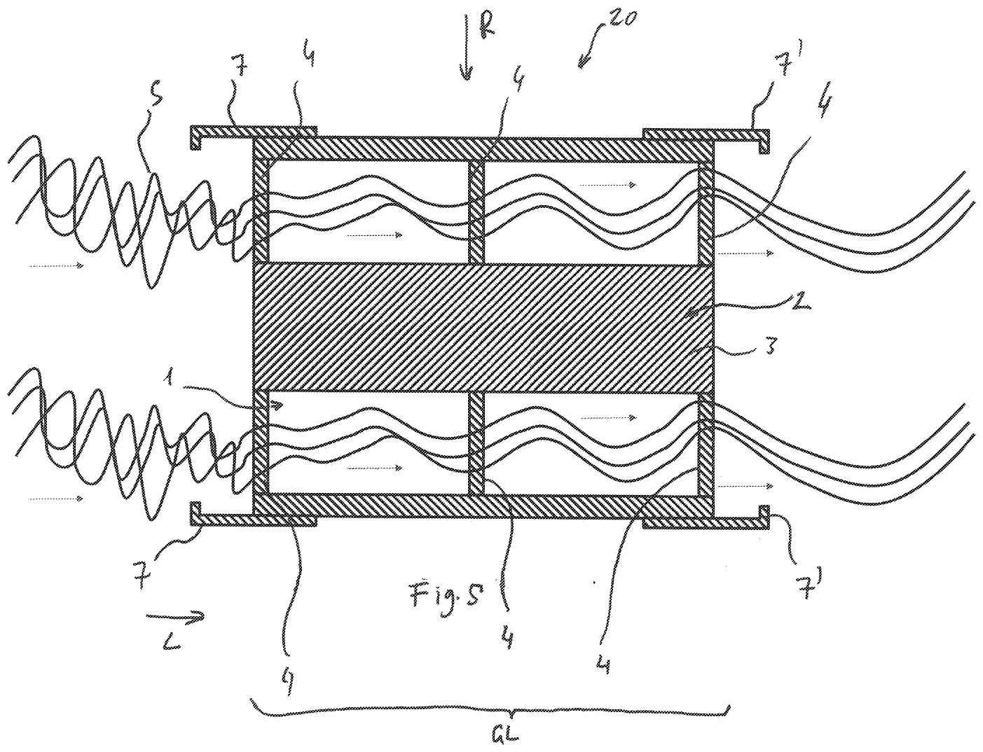

FIG. 5 now shows a cross section of the vacuum cleaner hose adapter 20 in FIG. 5. The central guiding body 3, which is arranged coaxially with the longitudinal direction L of the vacuum cleaner hose adapter 20 and is designed as a solid body, is clearly visible. The central guiding body 3, which is designed as a solid body, extends over the total length GL of the vacuum cleaner hose adapter 20 (with the exception of the overlapping retention rings 7, 7′).

It can clearly be seen in FIG. 5 that the respective spokes 4 essentially perform a supporting action for the guiding body 3. In the exemplary embodiment under consideration, a flow guiding effect of the spokes 4 is somewhat negligible. At any rate, it can clearly be seen that a highly turbulent suction flow S entering on the left-hand side is modified in the direction of an advantageous longitudinal vortex flow in the course of its passage through the vacuum cleaner hose adapter 20.

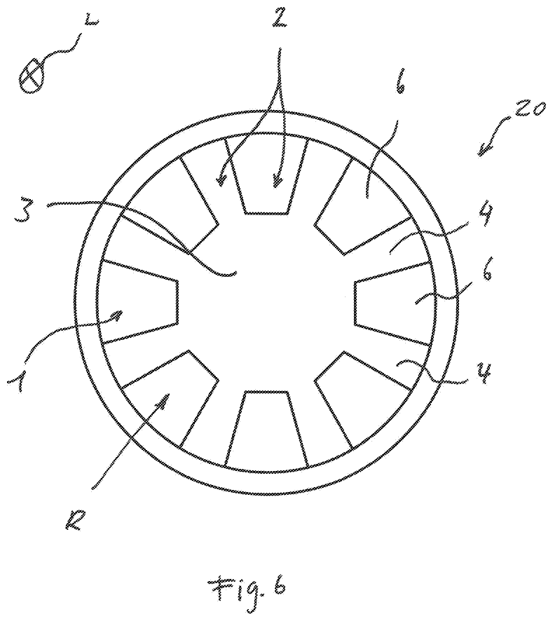

FIG. 6 shows another preferred exemplary embodiment of a vacuum cleaner hose adapter 20 in cross section. It can clearly be seen that the flow guiding geometry 2 has a cross section in the form of a sun wheel. In this case, it is formed by a central guiding body 3, which is designed as a solid body, and a plurality of radial spokes 4. In the exemplary embodiment shown, there is thus a total of six bypass channels 6.

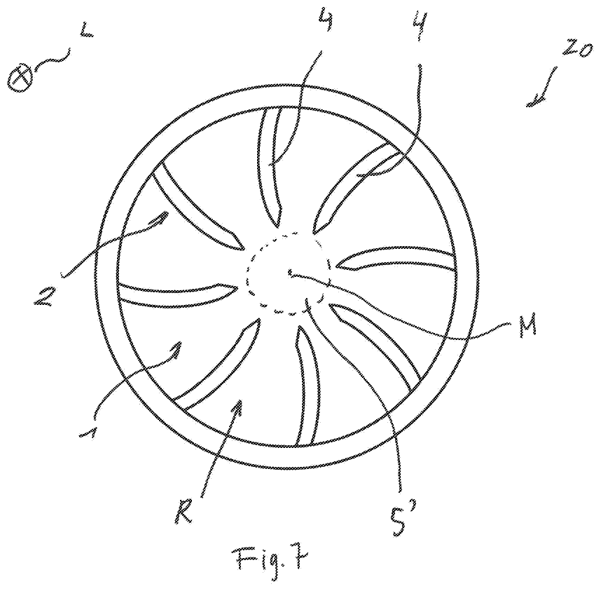

Another preferred exemplary embodiment of a vacuum cleaner hose adapter 20 according to the invention is illustrated in FIG. 7. The flow guiding geometry 2 is formed by a plurality of spokes 4, which extend inward in the radial direction R and, at the same time, are slightly curved. By way of example, eight radially inward-oriented spokes 4 are provided.

As can be seen from FIG. 7, the spokes do not extend as far as the center M of the vacuum cleaner hose adapter 20. As a result, a virtual flow channel 5′ remains coaxially-centrally within the vacuum cleaner hose adapter 20.

Although this is not visible from FIG. 7, the plurality of spokes 4 can extend over the total length GL of the vacuum cleaner hose adapter 20.

### LIST OF REFERENCE SIGNS

1 Inner lumen

2 Flow guiding geometry
3 Central guiding body

### 4 Spoke

5, 5′ Flow channel

6 Bypass channel

7, 7′ Retention ring

### 8, 8′ Lip

10 Vacuum cleaner hose
20 Vacuum cleaner hose adapter
100 Wet and dry vacuum cleaner
AD Outside diameter
AS Hose outside
GL Total length
ID Inside diameter
L Longitudinal direction
M Central point
R Radial direction
S Suction flow

What is claimed is:

1-15. (canceled)

16. A vacuum cleaner hose adapter for connecting to a vacuum cleaner hose of a wet and dry vacuum cleaner, the vacuum cleaner hose having an inner lumen extending in a longitudinal direction, the vacuum cleaner hose adapter comprising:
a flow guiding geometry formed within the vacuum cleaner hose adapter, the flow guiding geometry influencing a suction flow occurring during the operation of the wet and dry vacuum cleaner.

17. The vacuum cleaner hose adapter as recited in claim 16 wherein the flow guiding geometry has a central guiding body arranged coaxially with a vacuum cleaner hose adapter longitudinal direction

18. The vacuum cleaner hose adapter as recited in claim 17 wherein the central guiding body is designed as a solid body.

19. The vacuum cleaner hose adapter as recited in claim 17 wherein the central guiding body has a flow channel (5).

20. The vacuum cleaner hose adapter as recited in claim 16 wherein the flow guiding geometry has a plurality of spokes extending inwardly in the radial direction.

21. The vacuum cleaner hose adapter as recited in claim 16 wherein the flow guiding geometry extends over a total length of the vacuum cleaner hose adapter.

22. The vacuum cleaner hose adapter as recited in claim 16 wherein the flow guiding geometry has a cross section in the form of a sun wheel or a four-way lug wrench.

23. The vacuum cleaner hose adapter as recited in claim 16 wherein the vacuum cleaner hose adapter is designed as an intermediate adapter.

24. The vacuum cleaner hose adapter as recited in claim 16 wherein the vacuum cleaner hose adapter is designed as an end-located adapter.

25. The vacuum cleaner hose adapter as recited in claim 16 further comprising a retention element.

26. The vacuum cleaner hose adapter as recited in claim 25 wherein the retention element is a flexible retention ring.

27. The vacuum cleaner hose adapter as recited in claim 16 wherein the vacuum cleaner hose adapter is of double-shell design.

28. The vacuum cleaner hose adapter as recited in claim 16 wherein the vacuum cleaner hose adapter is composed of plastic.

29. A vacuum cleaner hose for connection to a wet and dry vacuum cleaner comprising: at least one vacuum cleaner hose section and at least one vacuum cleaner hose adapter as recited in claim 16 arranged or arrangeable on the vacuum cleaner hose section.

30. The vacuum cleaner hose as recited in claim 29 wherein the vacuum cleaner hose adapter is secured permanently on the vacuum cleaner hose.

31. The vacuum cleaner hose as recited in claim 29 wherein the vacuum cleaner hose is designed as a spiral hose.
